(19) United States
(12) Patent Application Publication
(10) Pub. No.: US 2014/0115456 A1
(43) Pub. Date: Apr. 24, 2014

(54) SYSTEM FOR ACCESSING SOFTWARE FUNCTIONALITY

(71) Applicant: Oracle International Corporation, (US)

(72) Inventors: Brent-Kaan William White, San Francisco, CA (US); Mark Vilrokx, San Mateo, CA (US); George Matthew Hackman, JR., San Mateo, CA (US)

(73) Assignee: Oracle International Corporation, Redwood Shores, CA (US)

(21) Appl. No.: 13/842,982

(22) Filed: Mar. 15, 2013

Related U.S. Application Data
(60) Provisional application No. 61/707,353, filed on Sep. 28, 2012.

(51) Int. Cl. G06F 3/0481

(52) U.S. Cl. CPC G06F 3/0481
USPC 715/708

(57) ABSTRACT

A system and method for facilitating user access to software functionality, such as enterprise-related software applications and accompanying actions and data. An example method includes receiving natural language input; displaying electronic text representative of the natural language input, in a conversation flow illustrated via user interface display screen; interpreting the natural language input and determining a command representative thereof; employing the command to determine and display a prompt, which is associated with a predetermined set of one or more user selectable items; providing a first user option to indicate a user selection responsive to the prompt; and inserting a representation of the user selection in the conversation flow. In a more specific embodiment, the first user option is provided via an input selection mechanism other than natural language, e.g., via a touch gesture, such that the conversation flow includes text representing user input other than purely text or voice-based input.

### CROSS REFERENCES TO RELATED APPLICATIONS

This application claims priority from U.S. Provisional Patent Application Ser. No. 61/707,353 (Atty. Docket No. ORACP0074P-ORA130295-US-PSP), entitled COMPUTING DEVICE WITH SPEECH CONTROL, filed on Sep. 28, 2012, which is hereby incorporated by reference as if set forth in full in this application for all purposes.

This application is related to the following application, U.S. patent application Ser. No. 13/715,776 (Atty. Docket No. ORACP0071-ORA130060-US-NP), entitled NATURAL LANGUAGE PROCESSING FOR SOFTWARE COMMANDS, filed on Dec. 14, 2012, which is hereby incorporated by reference, as if set forth in full in this specification:

### BACKGROUND

The present application relates to software and more specifically relates to software and accompanying graphical user interfaces that employ language input to facilitate interacting with and controlling the software.

Natural language processing is employed in various demanding applications, including hands free devices, mobile calendar and text messaging applications, foreign language translation software, and so on. Such applications demand user friendly mechanisms for efficiently interacting with potentially complex software via language input, such as voice.

Efficient language based mechanisms for interacting with software are particularly important in mobile enterprise applications, where limited display area is available to facilitate user access to potentially substantial amounts of data and functionality, which may be provided via Customer Relationship Management (CRM), Human Capital Management (HCM), Business Intelligence (BI) databases, and so on.

Conventionally, voice or language assisted enterprise applications exhibit design limitations that necessitate only limited natural language support and lack efficient mechanisms for facilitating data access and task completion. For example, inefficient mechanisms for translating spoken commands into software commands and for employing software commands to control software, often limit the ability of existing applications to employ voice commands to access complex feature sets.

Accordingly, use of natural language is typically limited to facilitating launching a software process or action, and not to implement or continue to manipulate the launched software process or action.

### SUMMARY

An example method facilitates user access to software functionality, such as enterprise-related software applications and accompanying actions and data. The example method includes receiving natural language input; displaying corresponding electronic text in a conversation flow illustrated via user interface display screen; interpreting the natural language input and determining a request or command representative thereof; employing the command to determine and display a prompt, which is associated with a predetermined set of one or more user selectable items; providing a first user option to indicate a user selection responsive to the prompt; and inserting a representation of the user selection in the conversation flow.

In a more specific embodiment, the first user option is provided via an input selection mechanism other than natural language, e.g., via a touch gesture, mouse cursor, etc. Alternatively, the user selection can be made via natural language input, e.g., voice input.

The set of one or more user selectable items may be presented via a displayed list of user selectable items. The representation of the user selection may include electronic text that is inserted after the electronic text representative of the first natural language input.

In the specific embodiment, the example method further includes displaying a second prompt inserted in the conversation flow after the representation of the user selection; providing a second user option to provide user input responsive to the second prompt via second natural language input; and inserting a representation of the second natural language input into the conversation flow after the second prompt.

In an illustrative embodiment, the example method may further include determining that the user command represents a request to view data; then determining a type of data that a user requests to view, and displaying a representation of requested data in response thereto. Examples of data types include, but are not limited to customer, opportunity, appointment, task, interaction, and note data.

The interpreting step may further include determining that the command represents a request to create a computing object. The computing object may include data pertaining to a task, an appointment, an interaction, etc.

The interpreting step may further include referencing a repository of user data, including speech vocabulary previously employed by the user, to facilitate estimating user intent represented by natural language input. The employing step may include referencing a previously accessed computing object to facilitate determining the prompt.

The user selection may include, for example, an indication of a computing object to be created or data of which to be displayed. The computing object may be maintained via an Enterprise Resource Planning (ERP) system.

The example method may further include providing one or more additional prompts, which are adapted to query the user for input specifying one or more parameters for input to a Web service to be called to create a computing object. An ERP server provides the Web service, and a mobile computing device facilitates receiving natural language input and displaying the conversation flow.

The server may provide metadata to the mobile computing device or other client device to adjust a user interface display screen illustrated via the client device. One or more Web services may be associated with the conversation flow based on the natural language input. The first prompt may include one or more questions, responses to which represent user selections that provide answers identifying one or more parameters to be included in one or more Web service requests. Examples of parameters include a customer identification number, an opportunity identification number, a parameter indicating an interaction type, and so on.

Hence, certain embodiments discussed herein facilitate efficient access to enterprise data and functionality in part by enabling creation of a hybrid natural language dialog or conversation flow that may include both text representative of user provided natural language input (e.g., voice); software generated natural language prompts; and text representing user input that was provided via touch gestures or other user input mechanisms.

For example, during a conversation flow, a user may use touch input to select an item from a list. The resulting selection may be indicated via text that is automatically inserted in the conversation flow. Integration of prompts, voice/text input/output, and other interface features into a conversation flow may be particularly useful for mobile enterprise applications, where navigation of conventional complex menus and software interfaces may otherwise be particularly difficult. Use of conversation context, e.g., as maintained via metadata, to direct the conversation flow and to accurately estimate user intent from user input may further facilitate rapid implementation of ERP operations/tasks, e.g., viewing enterprise data, creating data objects, and so on.

Hence, software components used to implement certain embodiments discussed herein may provide an application framework for enabling efficient use of natural language input, e.g., voice, to complete ERP actions, including accessing data, editing data, and creating data objects. Embodiments may accept varied language structures and vocabularies to complete relatively complex tasks via a simple conversation-based user interface. Multiple parameters required to invoke a particular software service may be simultaneously determined from a single instance of user input, using context-aware natural language processing mechanisms and accompanying metadata and past user inputs, including information about an interaction that a user is currently working on or previously worked on.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram of a first example system that accepts natural language input to facilitate user interaction with ERP software.

FIG. 2 is an example process flow diagram illustrating example sub-processes that may be implemented via the system of FIG. 1 to facilitate natural language control of a computing device.

FIG. 3A illustrates a first example user interface display screen, which may be implemented via the system of FIG. 1, and which illustrates a first example user interaction involving use of voice input to initiate creation of an interaction computing object.

FIG. 3B illustrates a second example user interface display screen presenting a list of user selectable options for insertion in to a conversation flow initiated in FIG. 3A.

FIG. 3C illustrates a third example user interface display screen showing insertion of a representation of a user selection made via the user interface display screen of FIG. 3B into the conversation flow initiated in FIG. 3A.

FIG. 4 illustrates a fourth example user interface display screen showing an alternative example conversation flow used to create an interaction computing object.

FIG. 5A illustrates a fifth example user interface display screen showing a first portion of a conversation flow used to create a task computing object.

FIG. 5B illustrates a sixth example user interface display screen illustrating a second portion of the conversation flow initiated in FIG. 5A.

FIG. 6A illustrates a seventh example user interface display screen showing a first portion of a conversation flow used to create an appointment computing object.

FIG. 6B illustrates an eighth example user interface display screen showing a second portion of the conversation flow initiated in FIG. 6A.

FIG. 7 illustrates a ninth example user interface display screen showing an alternative example conversation flow used to create an appointment computing object, where a single natural language input sentence is used by underlying software to populate multiple parameters used to create an appointment computing object.

FIG. 8A illustrates a tenth example user interface display screen showing a first portion of a conversation flow used to create a note computing object.

FIG. 8B illustrates an eleventh example user interface display screen showing a second portion of the conversation flow initiated in FIG. 8A.

FIG. 9A illustrates a twelfth example user interface display screen showing an example conversation flow used to view data associated with a specific opportunity computing object specified via natural language input.

FIG. 9B illustrates a thirteenth example user interface display screen showing an example conversation flow used to view a list identifying all user opportunity computing objects.

FIG. 10 illustrates a fourteenth example user interface display screen showing an example help menu that indicates various example enterprise actions that may be implemented via underlying software in response to natural language input and/or a combination of natural language input and other input.

FIG. 11A illustrates a fifteenth example user interface display screen, where various voice-activatable user options are displayed in an initial menu instead of (or in addition to) being displayed in a help menu.

FIG. 11B illustrates a sixteenth example user interface display screen, where various voice activatable user options are displayed in a second example menu, which has been adjusted in accordance with the current context of the conversation flow.

FIG. 12 is a flow diagram of a first example method adapted for use with the embodiments of FIGS. 1-11B.

FIG. 13 is a flow diagram of a second example method for facilitating implementing the embodiments of FIGS. 1-12 via use of a form and accompanying metadata to store parameters for use by software to implement one or more enterprise or actions.

### DETAILED DESCRIPTION OF EMBODIMENTS

For the purposes of the present discussion, an enterprise may be any organization of persons, such as a business, university, government, military, and so on. The terms “organization” and “enterprise” are employed interchangeably herein. Personnel of an organization, i.e., enterprise personnel, may include any persons associated with the organization, such as employees, contractors, board members, customer contacts, and so on.

An enterprise computing environment may be any computing environment used for a business or organization. A computing environment may be any collection of computing resources used to perform one or more tasks involving computer processing. An example enterprise computing environment includes various computing resources distributed across a network and may further include private and shared content on Intranet Web servers, databases, files on local hard discs or file servers, email systems, document management systems, portals, and so on.

ERP software may be any set of computer code that is adapted to facilitate implementing any enterprise-related process or operation, such as managing enterprise resources, managing customer relations, and so on. Example resources include Human Resources (HR) (e.g., enterprise personnel), financial resources, assets, employees, business contacts, and so on, of an enterprise. The terms “ERP software” and “ERP application” may be employed interchangeably herein. However, an ERP application may include one or more ERP software modules or components, such as user interface software modules or components.

Enterprise software applications, such as Customer Relationship Management (CRM), Business Intelligence (BI), Enterprise Resource Planning (ERP), and project management software, often include databases with various database objects, also called data objects or entities. For the purposes of the present discussion, a database object may be any computing object maintained by a database. A computing object may be any collection of data and/or functionality. Examples of computing objects include a note, appointment, a particular interaction, a task, and so on. Examples of data that may be included in an object include text of a note (e.g., a description); subject, participants, time, and date, and so on, of an appointment; type, description, customer name, and so on, of an interaction; subject, due date, opportunity name associated with a task, and so on. An example of functionality that may be associated with or included in an object includes software functions or processes for issuing a reminder for an appointment.

Enterprise data may be any information pertaining to an organization or business, including information about customers, appointments, meetings, opportunities, customer interactions, projects, tasks, resources, orders, enterprise personnel and so on. Examples of enterprise data include work-related notes, appointment data, customer contact information, descriptions of work orders, asset descriptions, photographs, contact information, calendar information, enterprise hierarchy information (e.g., corporate organizational chart information), and so on.

For clarity, certain well-known components, such as hard drives, processors, operating systems, power supplies, and so on, have been omitted from the figures. However, those skilled in the art with access to the present teachings will know which components to implement and how to implement them to meet the needs of a given implementation.

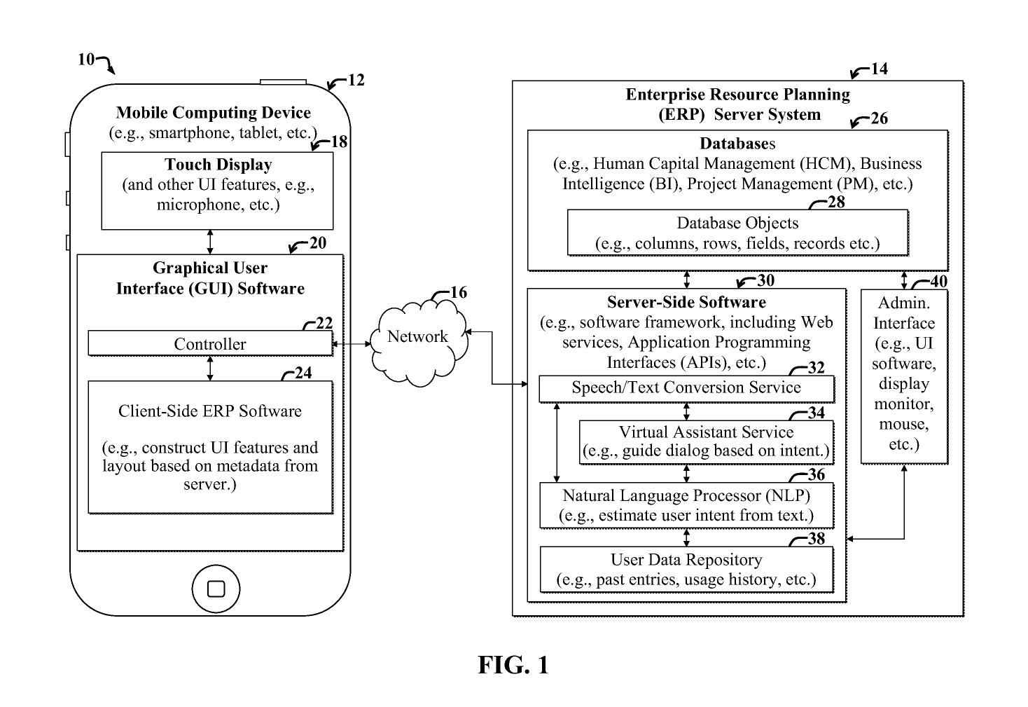

FIG. 1 is a diagram of a first example system 10 that accepts natural language input, e.g., from client-side user interface mechanisms 18 (e.g., microphone, software keypad, etc.) to facilitate user interaction with ERP software, including client-side software 20 and server-side software 26, 30. The example system 10 includes a client system 12 in communication with an ERP server system 14.

For the purposes of the present discussion, natural language may be any speech or representation of speech, i.e., spoken or written language. Similarly, natural language input may be any instruction, request, command, or other information provided via spoken or written human language to a computer. Examples of language input usable with certain embodiments discussed herein include voice commands, text messages (e.g., Short Message Service (SMS) text messages), emails containing text, direct text entry, and so on.

In the present example embodiment, the client system 10 includes user input mechanisms represented by a touch display 18 in communication with Graphical User Interface (GUI) software 20. The GUI software 20 includes a controller 22 in communication with client-side ERP software 24. The client-side GUI controller 22 communicates with the ERP server system 14 and accompanying server-side software 30 via a network 16, such as the Internet.

The server-side software 30 may include Web services, Application Programming Interfaces (APIs), and so on, to implement software for facilitating efficient user access to enterprise data and software functionality via a conversation flow displayed via the touch display 18, as discussed more fully below.

For the purposes of the present discussion, a conversation flow may be any displayed representation of a conversation that includes natural language or a representation of natural language. The terms conversation flow, dialog, speech thread, and conversation thread are employed interchangeably herein.

A conversation flow, as the term is used herein, may include representations of input provided via user interface mechanisms other than voice or typed text. For example, an answer to a question asked by software may be provided via user selection of an option from a list. A natural language representation of the user selected option may be inserted into the conversation flow.

For the purposes of the present discussion, software functionality may be any function, capability, or feature, e.g., stored or arranged data, that is provided via computer code, i.e., software. Generally, software functionality may be accessible via use of a user interface and accompanying user interface controls and features. Software functionality may include actions, such as retrieving data pertaining to a computing object (e.g., business object); performing an enterprise-related task, such as promoting, hiring, and firing enterprise personnel, placing orders, calculating analytics, launching certain dialog boxes, performing searches, and so on.

A software action may be any process or collection of processes or operations implemented via software. Additional examples of processes include updating or editing data in a database, placing a product order, displaying data visualizations or analytics, triggering a sequence of processes for facilitating automating hiring, firing, or promoting a worker, launching an ERP software application, displaying a dialog box, and so on.

The server-side software 30 may communicate with various databases 26, such as Human Capital Management (HCM), Business Intelligence (BI), Project Management (PM) databases, and so on, which maintain database objects 28. An administrator user interface 40 includes computer code and hardware for enabling an administrator to configure the server-side software 30 and various databases 26 to meet the needs of a given implementation.

In the present example embodiment, the server-side software 30 includes a speech/text conversion service module 32 in communication with a virtual assistant service module 34. Note however, that various modules of the server side software 30, such as the speech/text conversion service 32, may be implemented elsewhere, i.e., not on the ERP server system 14, without departing from the scope of the present teachings. For example, a particular embodiment uses a third party cloud module whereby a .wav file is sent over the Internet and text is received back by the ERP system. Another embodiment can be as illustrated in FIG. 1, where speech/text conversion can occur within the ERP server system. An advantage to performing the conversion within the ERP server system is that application and/or domain data might be better integrated into the system's functionality.

The speech/text conversion service module 32 includes computer code adapted to receive encoded speech, i.e., voice data, forwarded from the mobile computing device 12 (also called client device, client system, or client computer), and then convert the voice data into text. The speech/text conversion service 32 may also include computer code for converting computer generated text into audio data for transfer to and for playback by the mobile computing device 12.

Note that while certain features, such as speech-to-text conversion and vice versa are shown in FIG. 1 as being implemented server-side, and other features are implemented client-side, embodiments are not limited thereto. For example, speech-to-text and text-to-speech conversions may be performed client-side, i.e., on the mobile computing device 10, without departing from the scope of the present teachings.

The virtual assistant service module 34 of the server-side software 34 communicates with the speech/text conversion service module 32 and a Natural Language Processor (NLP) service module 36. The virtual assistant service module 34 may include computer code for guiding a conversation flow (also called dialog herein) to be displayed via the touch display 18 of the mobile computing device 12 and may further act as an interface between the speech/text conversion service 32 and the NLP module 36.

The virtual assistant service module 34 may include and/or call one or more additional Web services, such as a create-interaction service, a create-task service, a create-note service, a create-interaction service, a view-customers service, a view tasks service, and so on. The additional services are adapted to facilitate user selection and/or creation of database objects 28.

For the purposes of the present discussion, electronic text may be any electronic representation of one or more letters, numbers or other characters, and may include electronic representations of natural language, such as words, sentences, and so on. The terms “electronic text” and “text” are employed interchangeably herein.

The NLP module 36 may include computer code for estimating user intent from electronic text output from the speech/text conversion service module 32, and forwarding the resulting estimates to the virtual assistant service module 34 for further processing. For example, the virtual assistant service module 34 may include computer code for determining that a user has requested to create an appointment based on input from the NLP module 36 and then determining appropriate computer-generated responses to display to the user in response thereto.

For example, if a user has requested to create a note, the virtual assistant service module 34 may determine, with reference to pre-stored metadata pertaining to note creation, that a given set of parameters are required by a note-creation service that will be called to create a note. The virtual assistant service module 34 may then generate one or more prompts to be forwarded to the client-side GUI software 20 for display in a conversation flow presented via the touch display 18. The conversation flow may be guided by the virtual assistant service module 34 in a manner sufficient to receive user input to populate parameters required by the note-creation service.

For the purposes of the present discussion, metadata may be any data or information describing data or otherwise describing an application, a process, or set of processes or services. Hence, metadata may also include computer code for triggering one or more operations. For example, metadata associated with a given form field may be adapted to trigger population of another form field(s) based on input to the given form field.

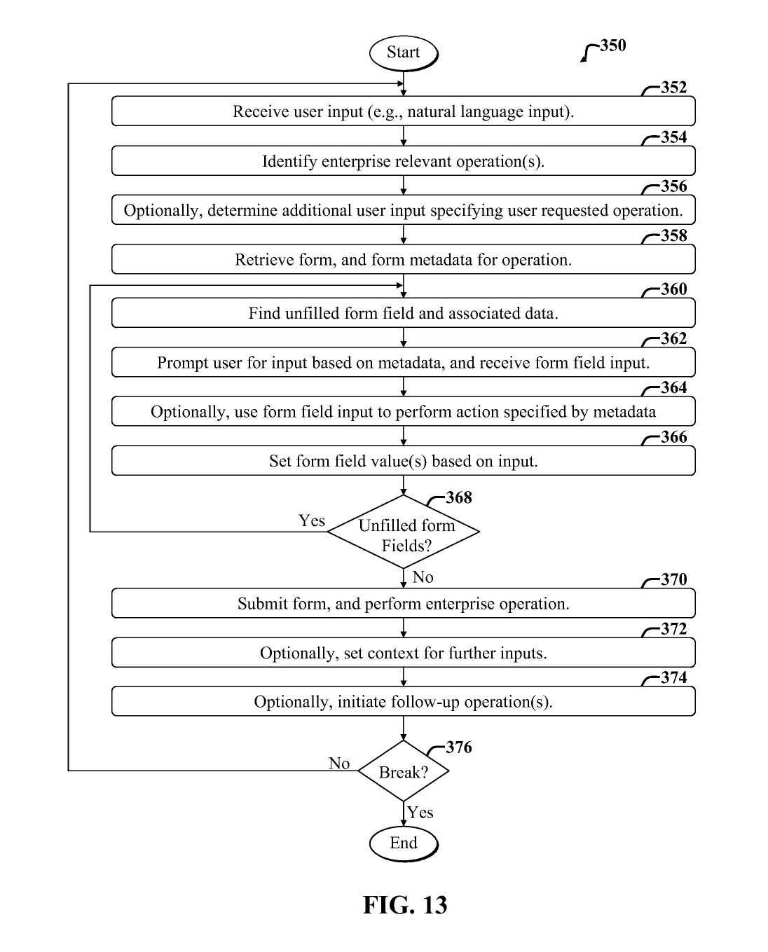

In certain implementations, certain parameters required by a given service, e.g., the note-creation service, interaction-creation service, and so on, may include a mix of default parameters, parameters derived via natural language user input, parameters derived from other user input (e.g., touch input), parameters inferred or determined based on certain user-specified parameters, and so on. Such parameters may be maintained in a form (which may be hidden from the user) that is submitted by the virtual assistant service module 34 to an appropriate Web service, also simply called service herein. As discussed more fully below with reference to FIG. 13, the form may include metadata describing certain fields, data included therein, and/or instructions associated therewith, to enable the virtual assistant service module 34 to efficiently populate the form with data in preparation for submitting the form to an appropriate service to implement a user requested action.

A user data repository 38 is adapted to maintain a history of user inputs, e.g., natural language inputs, to facilitate matching received natural language with appropriate commands, e.g., commands to view data pertaining to a database object and commands to create database objects and insert data therein.

For the purposes of the present discussion, a command may be any user input representative of a request or order to access software functionality, e.g., to trigger a software action, such as data retrieval and display, computing object creation, and so on. The terms command and request may be employed interchangeably herein.

The user data repository 38 may also be referenced by the virtual assistant service module 34 to facilitate determining a context of a given conversation flow. The context, in combination with user-intent estimates from the NLP module 36, may then be used to facilitate determining which prompts to provide to the user via the client-side GUI software 20 and accompanying touch display 18 to implement an enterprise action consistent with the user input, e.g., natural language input.

For the purposes of the present discussion, a prompt may be any question or query, either spoken, displayed, or otherwise presented to a user via software and an associated computing device.

The virtual assistant service module 34 may further include computer code for providing user interface metadata to the client-side GUI software 20 and accompanying client-side ERP software 24. The client-side ERP software 24 may include computer code for enabling rendering of a conversation flow and illustrating various user interface features (e.g., quotations, user-selectable lists of options, etc.) consistent with the metadata. The user interface metadata may include metadata generated by one or more services called by the virtual assistant service module 34 and/or by the virtual assistant service module 34 itself.

Hence, the mobile computing device 12 may receive instructions, e.g., metadata, from the server system 14 indicating how to lay out the information received from via the server-side software 30. For example, when a list of opportunities is returned to the mobile computing device 12, the list may contain metadata that informs the mobile computing device 12 that the list has a certain number of fields and how each field should appear in the list. This ensures that various user interface features can be generically displayed on different types of mobile computing devices. This further enables updating or adjusting the server-side software 30 without needing to change the mobile computing device 12 software 20.

In an example operative scenario, a user provides voice input to the mobile computing device 12 requesting to create an appointment for a business opportunity that the user has accessed. The voice input is then forwarded by the GUI controller 22 to the speech/text conversion service module 32 of the server-side software 30, which converts the audio data (i.e., voice data) into electronic text. The NLP module 36 then estimates that the user intends to create and populate an appointment computing object, and further determines, with reference to the user data repository 38, that the user has been working on a particular business opportunity.

Information pertaining to the business opportunity and the estimate that the user intends to create an appointment computing object is then forwarded to the virtual assistant service module 34. The virtual assistant service module 34 then determines one or more services to call to create an appointment computing object; determines parameters and information required to properly call the appointment-creation service, and then generates prompts designed to query the information from the user. The prompts are inserted into a conversation flow displayed via the touch display 18.

Examples of parameters to be obtained and corresponding prompts and actions are provided in the following table.

TABLE 1

| Parameter | Question to Ask | Additional Action |
|---|---|---|
| customer_id | Who is the customer? | findCustomerIdByName |
| | | findOpptysByCustomerid |
| opportunity_id | What is the opportunity? | |
| interaction_type | Was it a meeting or a | |
| | telephone interaction? | |
| interaction_details | Tell me the details of the | |
| | interaction. | |

Hence, the system 10 may use the known context of the operation or interaction (e.g., “Task,” “Appointment,” etc.) to direct the process of completing the operation for a key business object, such as a customer or opportunity (e.g., sales deal). The system 10 may load all of a given user's data (e.g., as maintained via the user data repository 38) as a predetermined vocabulary to be used for the speech control.

For example, if a user speaks a customer's name to start a dialog, such as “Pinnacle” the server-side software 30 may understand the preloaded customer name and respond with a question such as “O.K., Pinnacle is the customer, what would you like to create or view for Pinnacle?” The combination of enterprise data and understanding natural language can allow better recognition of the user's speech.

The server-side software 30 can retain the context of the high level business object, such as customer, when a new business process is initiated. For example, if a sales rep creates a note for a specific customer, “ACME,” and subsequently engages the system 10 to create a task, the system 10 can ask the user or implicitly understand that the new task is also for ACME.”

The mobile computing device 12 may interact with various individual components, e.g., modules (either directly or indirectly through a proxy) and may include additional logic, e.g., as included in the virtual assistant service module 34, that facilitates a smooth process.

In summary, a user may initiate a conversation flow by pressing a (microphone) button and beginning to speak. The resulting speech is sent to the speech/text conversion service module 32, which extracts a text string from the speech information.

In an alternative implementation, e.g., where speech/text translation occurs client-side, the string may be passed by the mobile computing device 12 to the virtual assistant service module 34. In the example alternative implementation, the virtual assistant 34 may selectively employ the NLP module 36 to interpret the string; to identify a dialog type that is associated with the intent; and to initiate the dialog and return dialog information, e.g., one or more prompts, to the mobile computing device 12.

The dialog may contain a list of questions to be answered before the intended action (e.g. create an interaction) can be completed. The mobile computing device 12 may ask these questions. After the user answers the questions, the answers are forwarded to the server-side software 30 for processing, whereby the virtual assistant service module 34 records the answers and extracts parameters therefrom until all requisite data is collected to implement an action.

As set forth above, but elaborated upon here, the action may be implemented via a Web service (WS) (e.g. create-interaction) that is provided by the ERP system 14. For example, a Web service may be associated with a conversation flow type, i.e., dialog type. The dialog will contain questions whose answers provide the parameters needed to complete the Web-service request. For example, a particular Web-service for creating an interaction in an ERP system may require four parameters (e.g., customer_id, opportunity_id, interaction_type and interaction details). Prompts are then formulated to invoke user responses that provide these parameters or sufficient information to programmatically determine the parameters. For example, a customer identification parameter may be calculated based on a customer name via invocation of an action or service to translate the name into a customer identification number for the Web service.

Hence, the system 10 illustrates an example architecture for implementing enterprise software that includes a speech/text conversion service module or engine 32 that is adapted to transform speech into text and vice versa; an NLP module or engine 36, which is adapted to estimate intent from text; a virtual assistant service module 34, which is adapted to guide a conversation flow based on the intent; and ERP databases and/or other ERP software applications 26 to provide business functionality to a client device 12 and accompanying GUI software 20 and user interface mechanisms 18.

The system 10 and accompanying architecture is adapted to enable use of speech to complete enterprise tasks (e.g., CRM opportunity management) and use of varied language structure and vocabulary to complete the enterprise tasks within a dialog-based interface. The dialog-based interface, rendered via the GUI software 20 and accompanying touch display 18, is further adapted to selectively integrate conventional user interface functionality (e.g., mechanisms/functionality for selecting items from one or more lists via touch gestures, mouse cursors, etc.) into a conversation flow. User data entries, such as selections chosen from a list via touch input, become part of the conversation flow and are visually integrated to provide a uniform and intuitive depiction.

In addition, the server-side software 30 is adapted to enable parsing a single user-provided sentence into data, which is then used to populate multiple form fields and/or parameters needed to call a particular service to implement an enterprise action. Furthermore, use of the user data repository 38 enables relatively accurate predictions or estimates of user intent, i.e., what the user is attempting to accomplish, based on not just recent, but older speech inputs and/or usage data.

Note that various modules and groupings of modules shown in FIG. 1 are merely illustrative and may vary, without departing from the scope of the present teachings. For example, certain components shown running on the client system 12 may instead be implemented on a computer or collection of computers that accommodate the ERP server system 14. Furthermore, certain modules may be implemented via a single machine or may be distributed across a network.

Those skilled in the art with access to the present teachings may employ readily available technologies to facilitate implementing an embodiment of the system 10. For example, Service Oriented Architectures (SOAs) involving use of Unified Messaging Services (UMSs), Business Intelligence Publishers (BIPs), accompanying Web services and APIs, and so on, may be employed to facilitate implementing embodiments discussed herein, without undue experimentation.

Furthermore, various modules may be omitted from the system 10 or combined with other modules, without departing from the scope of the present teachings. For example, in certain implementations, the speech/text conversion service 32 is not implemented on the ERP server system 14; one or more of the modules 32-38 may be implemented on the mobile computing device 12 or other server or server cluster, and so on.

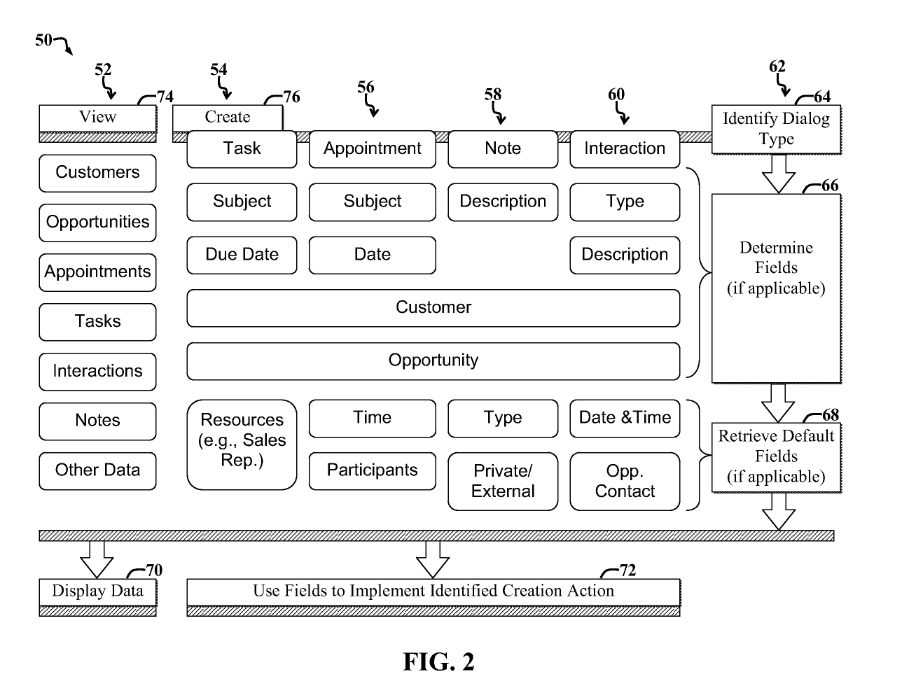

FIG. 2 is an example of a process 50 illustrating example sub-processes 64-72 that may be implemented via the system 10 of FIG. 1 to facilitate natural language control of a computing device. The example process 50 includes various steps 64-78 of a first column 62, each of which may be implemented by performing one or more operations indicated in adjacent columns 52-60, depending upon what initially occurs or what occurs in a previous step.

For example, a first dialog-type identification step 64 includes determining a dialog type based on previous natural language input, such as speech. In the present example embodiment, dialog types include View and Create dialog types. In general, conversation flows, i.e., dialogs, of the View type involve a user requesting to view enterprise data, such as information pertaining to customers, opportunities, appointments, tasks, interactions, notes, and so on. A user is said to view a customer, appointment, and so on, if data pertaining to a computing object associated with a customer, appointment, and so on, is retrieved by the system 10 of FIG. 1 and then displayed via the touch display 18 thereof.

Similarly, dialogs of the Create type involve a user requesting to create a task, appointment, note, or interaction. Note that a user is said to create a task, appointment, and so on, if the user initiates creation of a computing objet for a task, appointment, and so on, and then populates the computing object with data associated with the task, appointment, and so on, respectively.

In general, when the initial dialog type is identified as a View dialog, then one or more steps of a first column 52 (identified by a view header 74) are implemented in accordance with steps of the first column 62. Similarly, when the initial dialog type is identified as a Create dialog, then one or more steps of a create section (identified by a create header 76) are performed in accordance with steps of the first column 62. After steps of the view section 74 or create section 76 are performed in accordance with one or more corresponding steps of the first column 62, then data is either displayed, e.g., in a displaying step 70 or a computing object is created, e.g., in a creation step 72. If at any time, user input is not understood by the underlying software, a help menu or other user interface display screen may automatically be displayed.

With reference to FIGS. 1 and 2, in first example operative scenario, dialog-type identification step 64 prompts a user with a question and/or a user selectable list of options. A user response, e.g., as provided via initial natural language input, is then used to determine the dialog type.

For example, the initial natural language input may represent a user response to a prompt (i.e., question) initially displayed by the system 10 of FIG. 1 on the touch display 18 that asks “What's new with your sales activities?” An example user response might be “View my appointments.”

Subsequently, a field-determining step 66 is performed. In the present example operative scenario, the field-determining step 66 includes determining one or more parameters needed to call a Web service to retrieve a user specified appointment or set of appointments for display via the touch display 18 of FIG. 1. Any default parameters or fields required by the Web service may be retrieved and/or calculated via a field-retrieving step 68. Subsequently, the displaying step 70 involves running the Web service to retrieve and display specified appointment data.

For example a user may respond to an initial prompt by saying “Create an appointment.” The dialog-type identifying step 64 then determines that the dialog type is Create Appointment.

The subsequent field-determining step 66 then includes issuing prompts and interacting with the user via a conversation flow to obtain or otherwise determine parameters, e.g., subject, date, customer, and opportunity, indicated in the create-appointment column 56.

The subsequent field-retrieving step 68 then includes determining or deriving an appointment time, indications of participants that will be involved in the appointment, and any other fields that may be determined by the system 10 of FIG. 1 with reference to existing data collected in previous steps or collected with reference to the user data repository 38 of FIG. 1.

After sufficient parameters are collected, determined, or otherwise retrieved to invoke an appointment-creation Web service, then the appointment-creation Web service is called to complete creation of the appointment computing object.

Note that while only View and Create dialog types are indicated in FIG. 2, that embodiments are not limited thereto. For example additional or different dialog types and associated enterprise actions may be implemented in accordance with the general structure of the process 50, without departing from the scope of the present teachings. Furthermore, additional functionality can be provided, such as functionality for enabling editing of opportunity field values by voice.

Note that in general, a business process dialog or conversation flow need only capture a minimum amount of data pertaining to required fields, also called parameters, needed to call a Web service to implement an enterprise action associated with the dialog. If data is unavailable, then default data can be used to expedite the flow.

In the examples discussed more fully below, the user interface used to depict a dialog may show only bubble questions for required data fields. Default fields may be displayed on a summary screen. This may allow associating a business process, such as creating a task, with a high level business object such as a given customer or opportunity. Users can verify the data provided via a dialog before the data is submitted to a Web service. The parameters may be maintained via a hidden form that includes metadata and or embedded macros to facilitate completing fields of the form, which represent parameters to be used in calling a Web service used to implement an action specified by a user via a conversation flow.

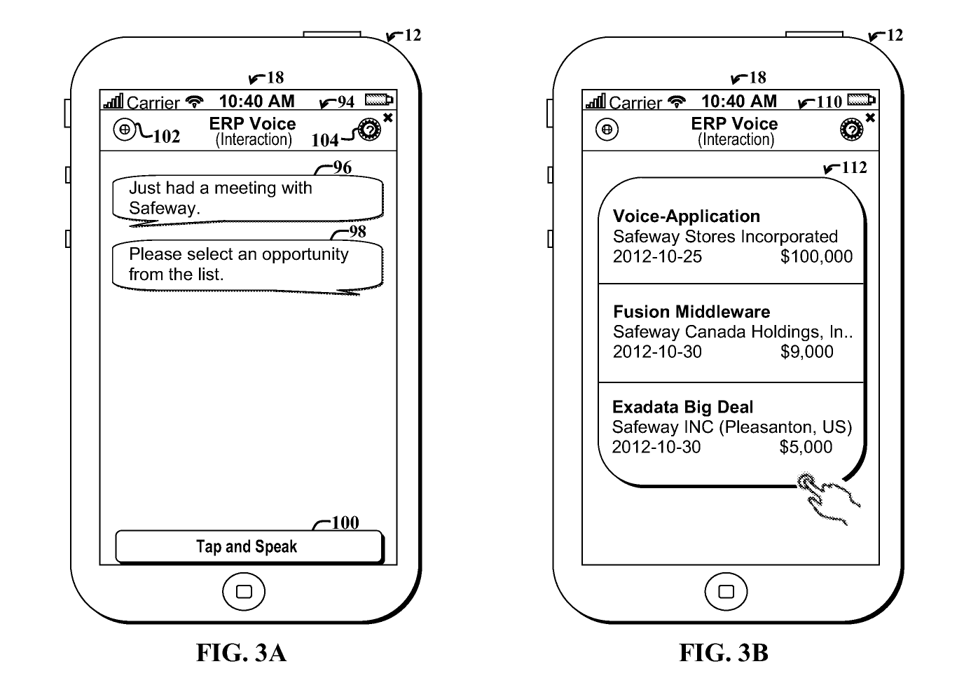

FIG. 3A illustrates a first example user interface display screen 94, which may be implemented via the system 10 of FIG. 1, and which may be displayed via the touch screen 18 thereof. The user interface display screen 94 which illustrates a first example portion 96-98 of a conversation flow involving use of voice input to initiate creation of an interaction computing object, e.g., in accordance with the interaction column 60 and corresponding steps 64-72 of FIG. 2.

For the purposes of the present discussion, an interaction may be any activity or description of an activity to occur between (or that otherwise involves as participants in the activity) two or more business entities or representatives thereof. Depending upon the context, an interaction may alternatively refer to a user-software interaction that involves a set of activities performed when a user provides input and receives output from software, i.e., when a user interacts with software and an accompanying computing device. In general, such user-software interactions discussed herein involve conversation flows involving natural language, or hybrid conversation flows involving a combination of natural language inputs and outputs, and other types of inputs and outputs, such as inputs provided by applying a touch gesture to a menu, as discussed more fully below.

For the purposes of the present discussion, a user interface display screen may be any software-generated depiction presented on a display, such as the touch display 18. Examples of depictions include windows, dialog boxes, displayed tables, and any other graphical user interface features, such as user interface controls, presented to a user via software, such as a browser. User interface display screens may include various graphical depictions, including visualizations, such as graphs, charts, diagrams, tables, and so on.

The example user interface display screen 94 includes various user interface controls, such as a reset icon 102, a help icon 104, and a tap-and-speak button 100, for resetting a conversation flow, accessing a help menu, or providing voice input, respectively.

For the purposes of the present discussion, a user interface control may be any displayed element or component of a user interface display screen, which is adapted to enable a user to provide input, view data, and/or otherwise interact with a user interface. Additional examples of user interface controls include drop down menus, menu items, tap-and-hold functionality (or other touch gestures), and so on. Similarly, a user interface control signal may be any signal that is provided as input for software, wherein the input affects a user interface display screen and/or accompanying software application associated with the software.

In the present example embodiment, a user begins the conversation flow 96-98 by speaking or typing a statement indicating that the user just had a meeting. This results in corresponding input text 96. The initial user input 96 is then parsed and analyzed by the underlying software to determine that the dialog type is a Create type dialog, and more specifically, the dialog will be aimed at creating an interaction computing object for a Safeway customer. Accordingly, the underlying software may determine multiple parameters, e.g., interaction type, description, customer name, and so on, via a user statement 96, such as “Just had a meeting with Safeway.”

Note that the underlying software may infer a “Create Interaction Dialog” intent from the phrase “Just had a meeting with Safeway” with reference to predetermined (e.g., previously provided) information, e.g., usage context. For example, user, such as a sales representative, may frequently create an interaction after a meeting with a client. Since the underlying software has access to the user's usage history and can interpret the term “meeting,” the underlying software can infer that the user intends to create a meeting interaction. Hence, this ability to understand/infer that the user intends to create a meeting interaction is based on contextual awareness of post meeting, which may be determined with reference to a user's usage history, e.g., as maintained via the user data repository 38 of FIG. 1.

The software responds by prompting the user to provide information pertaining to any missing parameters or fields, e.g., by providing an opportunity-requesting prompt 98, asking the user to select an opportunity from a list. Subsequently, a list may be displayed with user selectable options, as discussed more fully below with reference to FIG. 3B.

FIG. 3B illustrates a second example user interface display screen 110 presenting a list 112 of user selectable options for insertion in to a conversation flow initiated in FIG. 3A.

In the present example embodiment, a user employs a touch gesture, e.g., a tap gesture applied to the touch display 18, to select an opportunity from the list 112; specifically, an opportunity called Exadata Big Deal. An indication of the selected opportunity is then inserted into the conversation flow 96-98 of FIG. 3A after the opportunity-requesting prompt 98, as shown in FIG. 3C.

FIG. 3C illustrates a third example user interface display screen 120 showing insertion of a representation of a user selection 126 made via the user interface display screen 110 of FIG. 3B into the conversation flow 96-128 initiated in FIG. 3A. The menu-based user selection 126 is represented as natural language.

After insertion of the user selection 126, the underlying software prompts the user for additional details about the user interaction with the opportunity Exadata Big Deal, via a details-requesting prompt 128. The conversation flow then continues until a user exits or resets the conversation flow or until all parameters, e.g., as shown in column 60 of FIG. 2 are obtained as needed to invoke a Web service or other software to implement the creation step 72 of FIG. 2.

Hence, FIGS. 3A-3C depict a hybrid user-software interaction that involves natural language input, output, and further includes user input other than natural language input, e.g., input provided via touch input. The input provided via touch (e.g., indicating Exadata Big Deal) is integrated into the conversation flow 96-98 as though it were implemented via natural language input.

Such hybrid functionality may facilitate implementation of complex tasks that may otherwise be difficult to implement via natural language alone. Note, however, that alternatively, a user may indicate “Exadata Big Deal” via voice input, e.g., by pressing the tap-and-speak button 100 and speaking into the mobile computing device 12, without departing from the scope of the present teachings. Furthermore, opportunity information may be initially provided by a user, thereby obviating a need to display the list 112 of FIG. 3B.

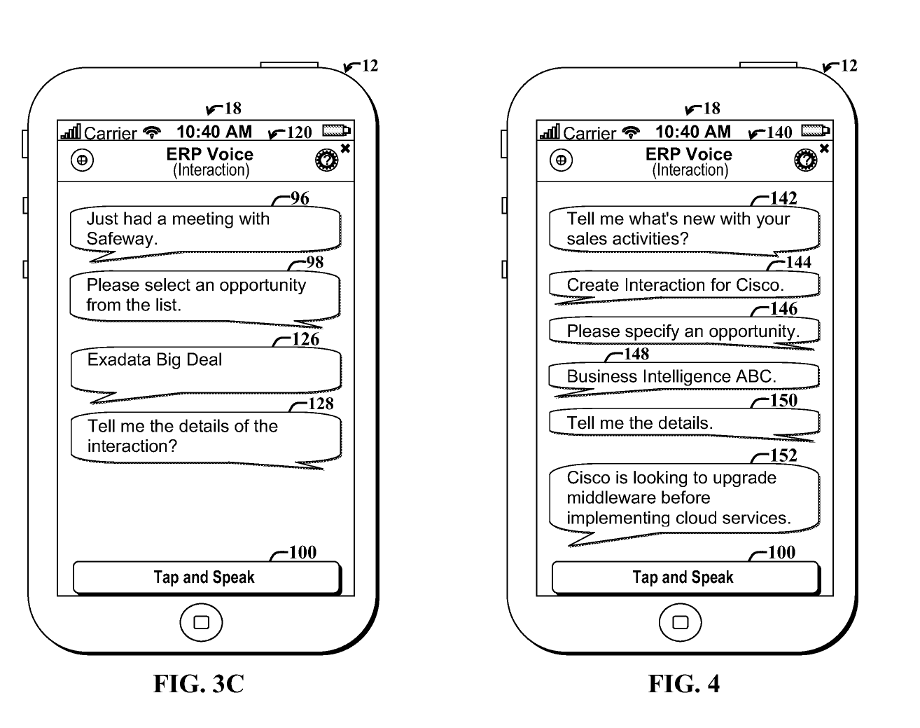

FIG. 4 illustrates a fourth example user interface display screen 140 showing an alternative example conversation flow 142-152 used to create an interaction computing object.

In FIG. 4, the underlying software prompts the user, via a first prompt 142, to indicate information pertaining to sales activities. In a first user response 144, the user requests to create an interaction for Cisco 144, thereby simultaneously suggesting that the user intends to create an interaction computing object for a customer Cisco.

A second system prompt 146 asks a user to specify an opportunity. In a second user response 148, the user indicates, e.g., by providing voice input, that the opportunity is called “Business Intelligence ABC.” A third system prompt 150 asks for additional details pertaining to “Business Intelligence ABC.”

In a third user response 152, a user provides voice or other text input that represents additional details to be included in a computing object of the type “Interaction” for the customer “Cisco” and the opportunity “Business Intelligence ABC.” Data provided in the third user response 152 may be stored in association with the created computing object.

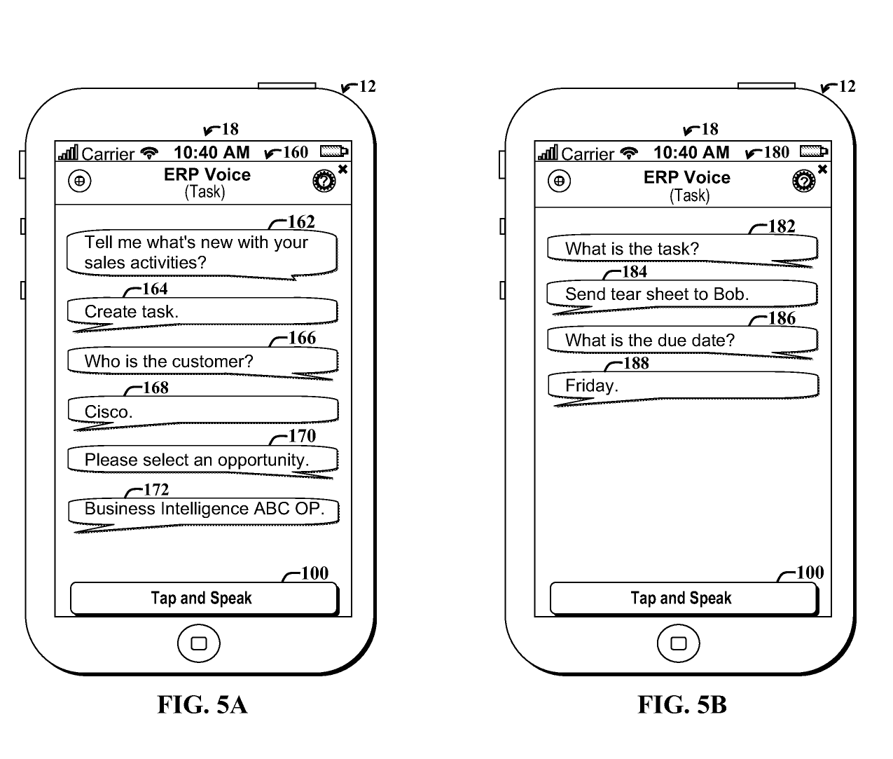

FIG. 5A illustrates a fifth example user interface display screen 160 showing a first portion 162-172 of a conversation flow used to create a task computing object. The conversation flow 162-172 is guided, e.g., by the virtual assistant service module 34 of FIG. 1, to obtain parameters identified in the task-creation column 54 of FIG. 2 in accordance with the corresponding steps 64-68 of the process 50 of FIG. 2.

In response to a first system prompt 162 asking what is new with a user's sales activities, a user subsequently requests to create a task via a create-task request 164. The system uses the user input 164 to determine that the dialog is of type “Create,” and specifically, that the dialog will be used to create a task computing object. This information may be stored as one or more parameters in an underlying form field in preparation for submission of the form to a task-creating Web service.

The system responds by asking who the customer is via a customer-requesting prompt 166. A user response 168 indicates that customer is Cisco.

The system then responds with an opportunity-requesting step 170, asking the user to select an opportunity. A user responds by indicating the opportunity is “Business Intelligence ABC Opportunity” in an opportunity-identifying step 172. Note that an intervening list of available opportunities may be displayed, whereby a user may select an opportunity from a list, e.g., the list 112 of FIG. 3B, without departing from the scope of the present teachings.

FIG. 5B illustrates a sixth example user interface display screen 180 illustrating a second portion 182-188 of the conversation flow 162-172 initiated in FIG. 5A.

After a user identifies an opportunity associated with a task, the system prompts the user for information about the task via a task-requesting prompt 182. The user responds via a task-indicating response 184 to “Send tear sheet to Bob.”

The system then prompts the user to specify a due date for the task via a due-date requesting prompt 186. The user responds via a due-date indicating response 188 that the due date is “Friday.” Various user responses 168, 172, 184, 188 of FIGS. 5A-5B may represent parameters or form fields, which the underlying system stores and forwards to an appropriate task-creating Web service, e.g., as maintained via the server-side software 30 of FIG. 1.

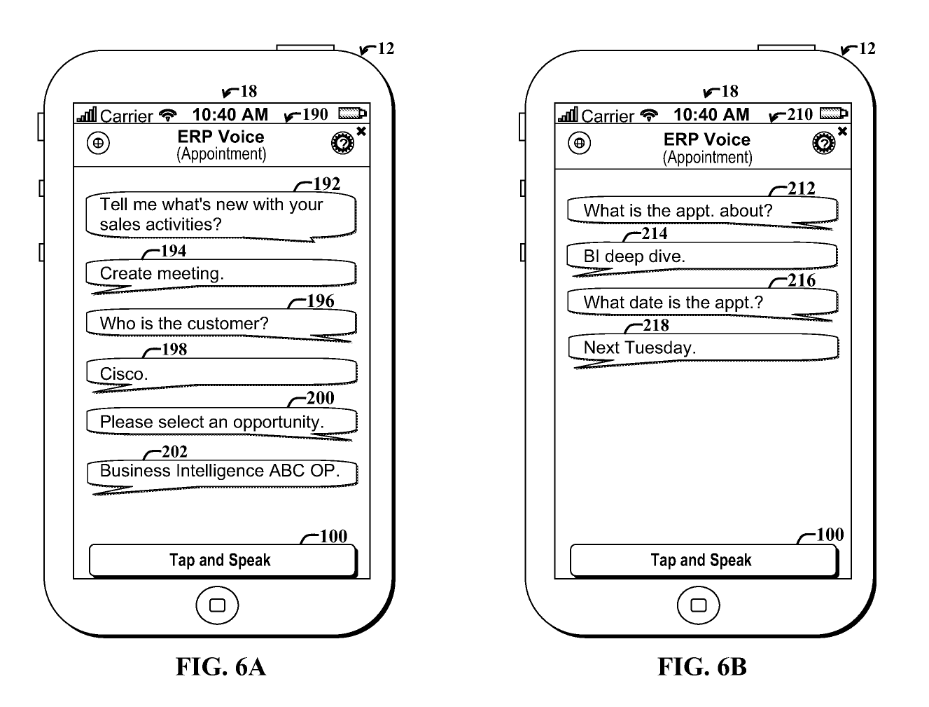

FIG. 6A illustrates a seventh example user interface display screen 190 showing a first portion 192-202 of a conversation flow used to create an appointment computing object. The conversation flow 192-202 is guided, e.g., by the virtual assistant service module 34 of FIG. 1, to obtain parameters identified in the appointment-creation column 56 of FIG. 2 in accordance with the corresponding steps 64-68 of the process 50 of FIG. 2.

In response to a first system prompt 192 asking what is new with a user's sales activities, a user subsequently requests to create a meeting, which is interpreted to mean “appointment,” via a create-appointment request 194. The system uses the user input 194 to determine that the dialog is of type “Create,” and specifically, that the dialog will be used to create an appointment computing object.

The system responds by asking who the customer is via a subsequent customer-requesting prompt 196. A user customer-indicating response 198 indicates that customer is Cisco.

The system then responds with a subsequent opportunity-requesting step 200, asking the user to select an opportunity. A user responds by indicating the opportunity is “Business Intelligence ABC Opportunity” in a subsequent opportunity-identifying prompt 202. Note that an intervening list of available opportunities may be displayed, whereby a user may select an opportunity from a list, e.g., the list 112 of FIG. 3B, without departing from the scope of the present teachings.

FIG. 6B illustrates an eighth example user interface display screen 210 showing a second portion 212-218 of the conversation flow 192-202 initiated in FIG. 6A.

After a user identifies an opportunity associated with an appointment, e.g., meeting, the system prompts the user for information about the appointment via an appointment-requesting prompt 212. The user responds via an appointment-indicating response 214 that the appointment pertains to “BI deep dive.”

The system then prompts the user to specify an appointment date via a date-requesting prompt 216. The user responds via a date-indicating response 218 that the appointment date is “Next Tuesday.” Various user responses 198, 202, 214, 218 of FIGS. 6A-6B may represent parameters or form fields, which the underlying system stores and forwards to an appropriate appointment-creating Web service, e.g., as maintained via the server-side software 30 of FIG. 1.

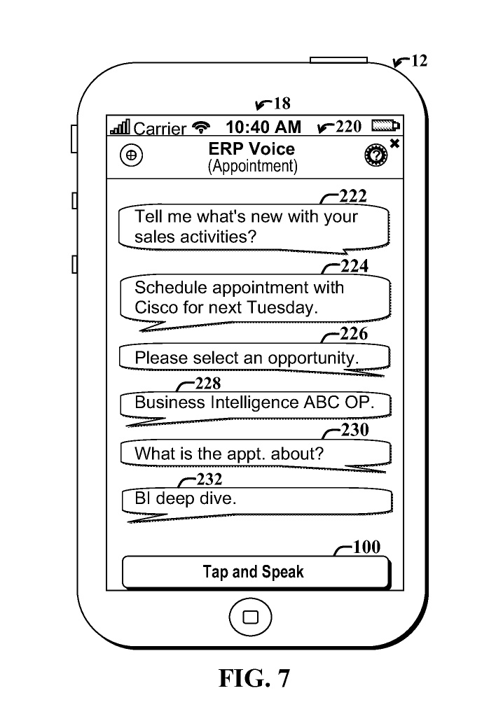

FIG. 7 illustrates a ninth example user interface display screen 220 showing an alternative example conversation flow 222-232 used to create an appointment computing object, where a single natural language input sentence 224 is used by underlying software to populate multiple parameters (e.g., dialog type, customer name, and date) used to create an appointment computing object.

In response to a first system prompt 222 asking what is new with a user's sales activities, a user subsequently requests to schedule an appointment with a customer Cisco for a date of next Tuesday, via the initial input sentence 224.

The system uses the user input 224 to determine that the dialog is of type “Create,” and specifically, that the dialog will be used to create an appointment computing object, which is characterized by a date parameter of next Tuesday. This information may be stored as one or more parameters in an underlying form field in preparation for submission of the form to an appointment-creating Web service.

Any additional information, e.g., parameters, needed to invoke an appointment-creating Web service, is obtained by the underlying system by issuing additional user prompts. For example, the system subsequently prompts the user to specify an opportunity via an opportunity-requesting prompt 226. The user may select an opportunity from a list, or alternatively, provide voice input to indicate that the opportunity is, for example “Business Intelligence ABC Opportunity” 228.

A subsequent appointment-requesting prompt 212 prompts the user for information about the appointment. The user responds by indicating that the appointment is about “BI deep dive” 232.

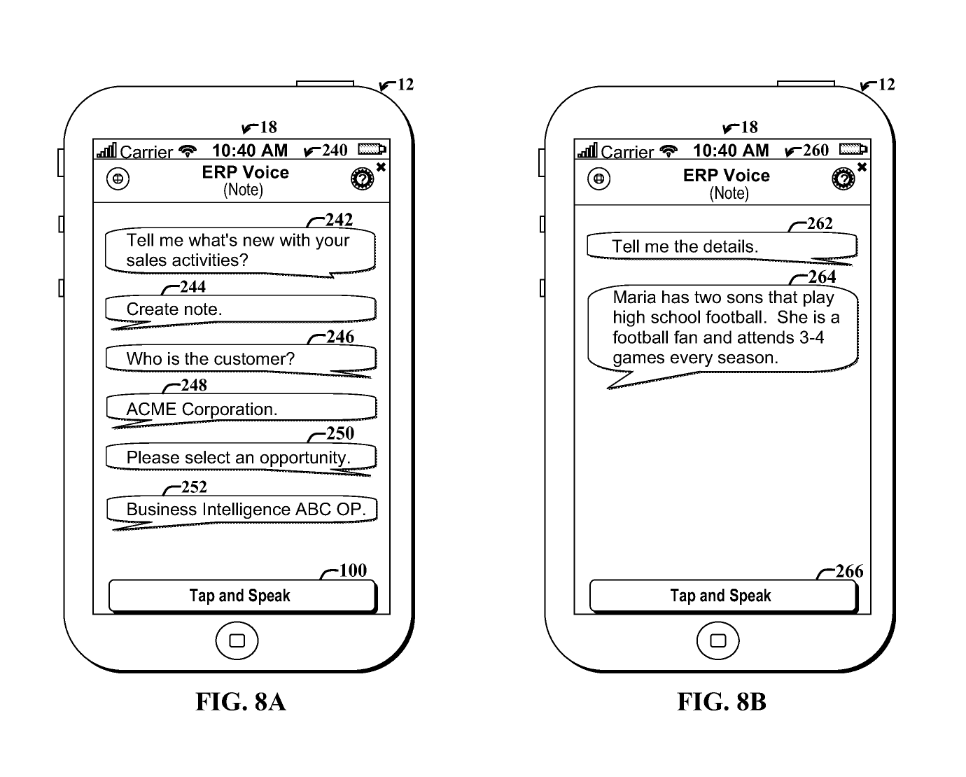

FIG. 8A illustrates a tenth example user interface display screen 240 showing a first portion of a conversation flow 242-252 used to create a note computing object. The conversation flow 242-252 is guided, e.g., by the virtual assistant service module 34 of FIG. 1, to obtain parameters identified in the note-creation column 58 of FIG. 2 in accordance with the corresponding steps 64-68 of the process 50 of FIG. 2.

In response to a first system prompt 242 asking what is new with a user's sales activities, a user subsequently requests to create a note, via a note-creation request 244. The system uses the user input 244 to determine that the dialog is of type “Create,” and specifically, that the dialog will be used to create a note computing object.

The system responds by asking who the customer is via a subsequent customer-requesting prompt 246. A user customer-indicating response 248 indicates that customer is ACME Corporation.

The system then responds with a subsequent opportunity-requesting prompt 250, asking the user to select an opportunity. A user responds by indicating the opportunity is “Business Intelligence ABC Opportunity” in a subsequent opportunity-identifying step 252. Note that an intervening list of available opportunities may be displayed, whereby a user may select an opportunity from a list, e.g., the list 112 of FIG. 3B, without departing from the scope of the present teachings.

FIG. 8B illustrates an eleventh example user interface display screen 260 showing a second portion 262-264 of the conversation flow 242-252 initiated in FIG. 8A.

After a user identifies an opportunity associated with a note, the system prompts the user for information about the note via a note-details requesting prompt 262. The user responds via a note-indicating response 264 by speaking, typing, or otherwise entering a note, e.g., “Maria has two sons . . . .”

The system then prompts the user to specify an appointment date via a date-requesting prompt 216. The user responds via a date-indicating response 218 that the appointment date is “Next Tuesday.” Various user responses 198, 202, 214, 218 of FIGS. 6A-6B may represent parameters or form fields, which the underlying system stores and forwards to an appropriate appointment-creating Web service, e.g., as maintained via the server-side software 30 of FIG. 1.

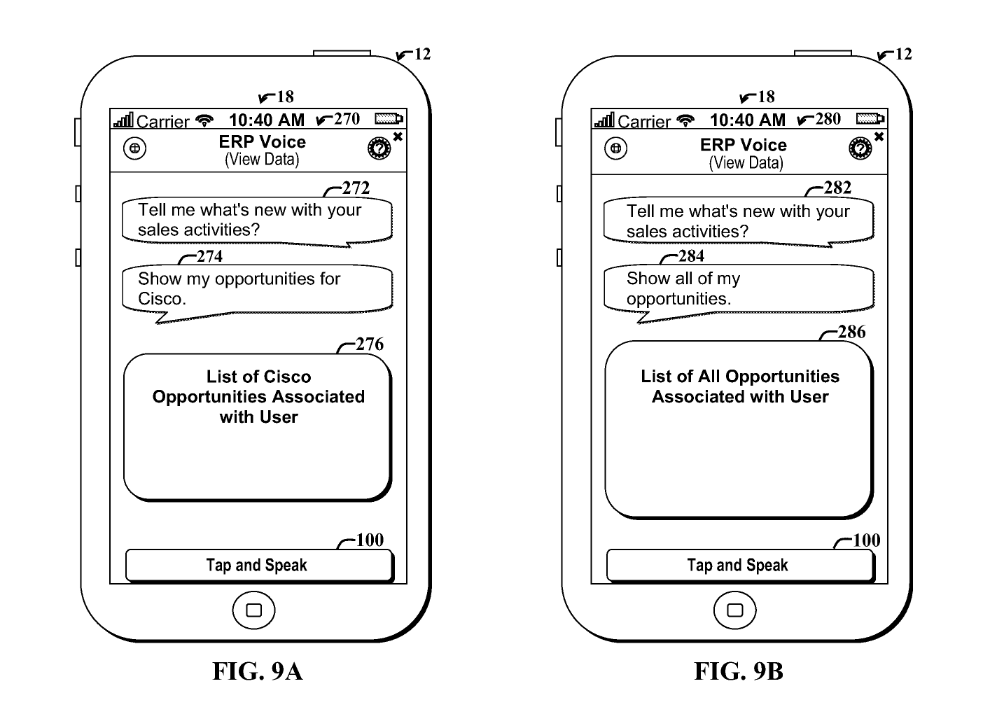

FIG. 9A illustrates a twelfth example user interface display screen 270 showing an example conversation flow 272-276 used to view data associated with a specific opportunity computing object specified via natural language input. The conversation flow 272-276 is guided, e.g., by the virtual assistant service module 34 of FIG. 1, to obtain parameters identified in the view column 52 of FIG. 2 in accordance with the corresponding steps 64-68 of the process 50 of FIG. 2.

In response to a first system prompt 272 asking what is new with a user's sales activities, a user subsequently requests to view opportunities for a customer Cisco via a view-requesting response 274. The system uses the user input 274 to determine that the dialog is of type “View” and specifically, that the dialog will be used to view opportunities. An additional customer parameter, i.e., “Cisco,” is provided in via the user input 274.

The system determines from the user input “Show my opportunities . . . ” 274 that the user requests to view all opportunities for the customer Cisco. Accordingly, the system has sufficient parameters to call a Web service to retrieve and display a user's Cisco opportunity computing objects (e.g., from one or more of the databases 26 of FIG. 1). The user's Cisco opportunities are then indicated, i.e., listed, in a subsequently displayed opportunity list 276, which is integrated into the conversation flow 272-276 and may be presented via natural language or via other indicators or icons representing a user's previously stored Cisco opportunities.

FIG. 9B illustrates a thirteenth example user interface display screen showing an example conversation flow used to view a list identifying all user opportunity computing objects. The conversation flow 282-286 is guided, e.g., by the virtual assistant service module 34 of FIG. 1, to obtain parameters identified in the view column 52 of FIG. 2 in accordance with the corresponding steps 64-68 of the process 50 of FIG. 2.

In response to a first system prompt 282 asking what is new with a user's sales activities, a user subsequently requests to view all opportunities response 284 indicating “Show all of my opportunities. The system uses the user input 284 to determine that the dialog is of type “View” and specifically, that the dialog will be used to view all of a user's opportunities.

The system now has sufficient parameters to call a Web service to retrieve and display all of a user's opportunity computing objects (e.g., from one or more of the databases 26 of FIG. 1). The user's opportunities are then indicated, i.e., listed, in a subsequently displayed opportunity list 286, which is integrated into the conversation flow 282-286 and may be presented via natural language or via other indicators or icons representing a user's previously stored opportunities.

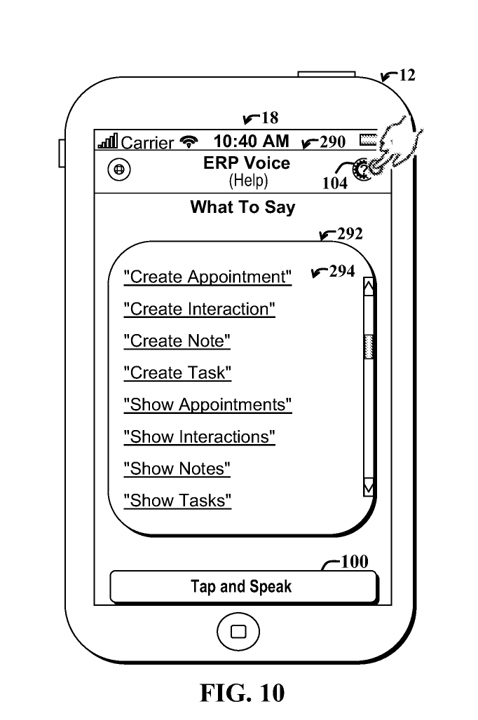

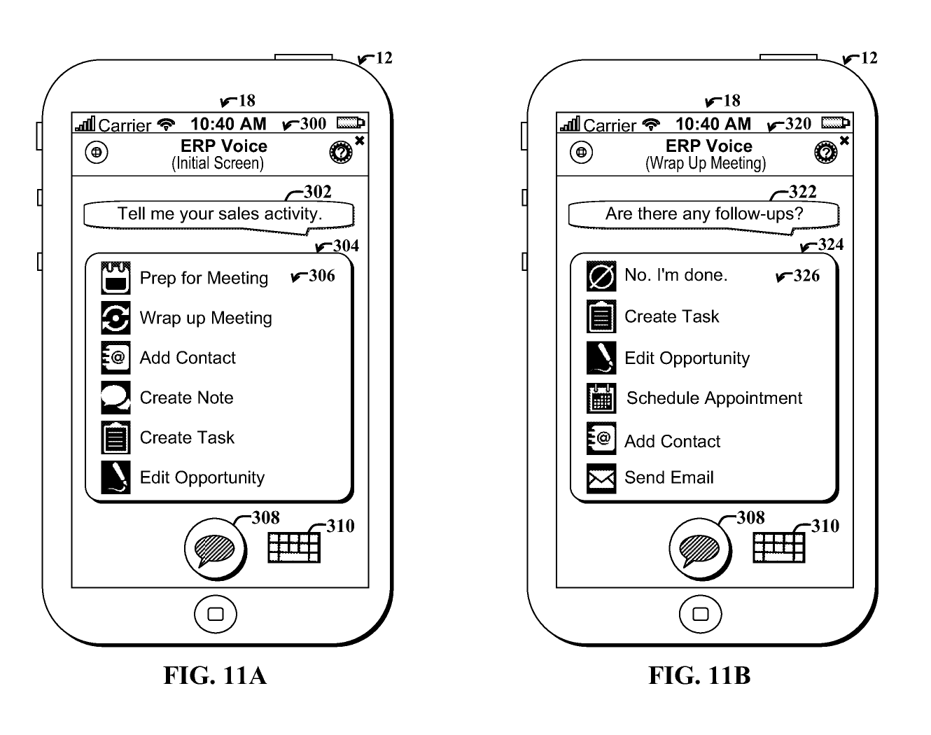

FIG. 10 illustrates a fourteenth example user interface display screen 290 showing an example help menu 292 that indicates various example enterprise actions 294 that may be implemented via underlying software in response to natural language input and/or a combination of natural language input and other input. The help menu 292 may be displayed in response to user selection of the help button 104 or in response to a user speaking the word “Help.” Alternatively, the list of items 294 indicating what to say may be included in an initial menu that is presented to a user when running the underlying software, as discussed more fully below with reference to FIGS. 11A-11B.

The list 294 may represent a list of things that a user may say or speak to initiate performance of one or more corresponding enterprise actions. Examples include “Create Appointment,” “Create Interaction,” “Create note,” and so on, as indicated in the help menu 292.

FIG. 11A illustrates a fifteenth example user interface display screen 300, where various voice-activatable user options 306 are displayed in an initial menu 304 instead of (or in addition to) being displayed in a help menu. The menu 304 may be displayed in combination with an initial system prompt 302 asking a user to specify information about a user's sales activities.

The example user options 306 may represent both suggestions as to what a user may say and may include user-selectable icons that a user may select to initiate a particular type of dialog. In certain embodiments, various instances of menus may occur at different portions of a conversation flow to facilitate informing the user as to what the system can understand. Note however, that the system may use natural language processing algorithms to understand or estimate intent from spoken language that differs from items 306 listed in the menu 304.

For illustrative purposes, an alternative tap-and-speak button 308 and a soft-keyboard-activating button 310 are shown for enabling a user to speak or type user input, respectively.

FIG. 11B illustrates a sixteenth example user interface display screen 320, where various voice activatable user options 326 are displayed in a second example menu 324, which has been adjusted in accordance with the current context of the conversation flow.

In the present example embodiment, the system prompts a user to specify information about follow-ups, via a follow-up requesting prompt 322. The accompanying menu 324 provides example suggestions 326 as to what a user may say or otherwise input to facilitate proceeding with the current conversation flow.

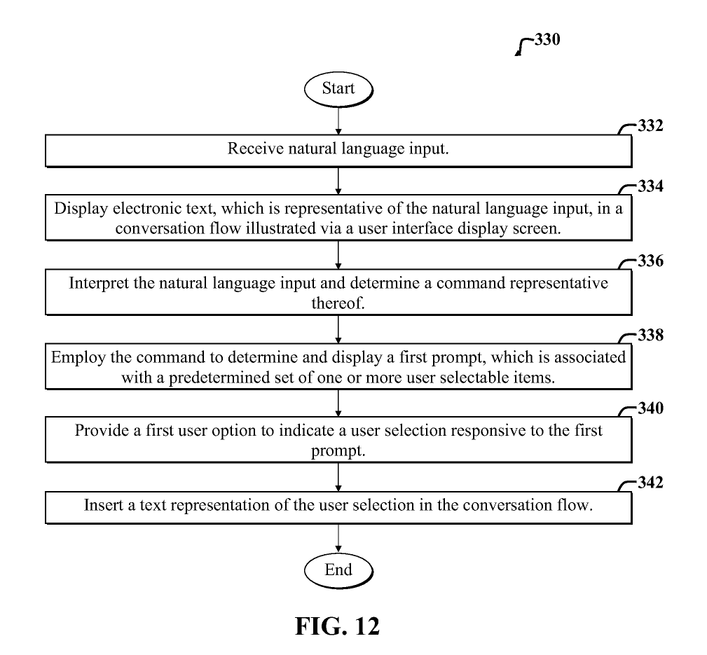

FIG. 12 is a flow diagram of a first example method 330 adapted for use with the embodiments of FIGS. 1-11B. The example method 330 pertains to use of a hybrid conversation flow that includes both natural language input and touch-screen input or other input, which is integrated into a conversation flow.

The example method 330 includes a first step 332, which involves receiving natural language input provided by a user.

A second step 334 includes displaying electronic text representative of the natural language input, in a conversation flow illustrated via a user interface display screen.

A third step 336 includes interpreting the natural language input and determining a command representative thereof.

A fourth step 338 includes employing the command to determine and display a first prompt, which is associated with a predetermined set of one or more user selectable items.

A fifth step 340 includes providing a first user option to indicate a user selection responsive to the first prompt.

A sixth step 342 includes inserting a representation of the user selection in the conversation flow.

Note that the method 330 may be augmented with additional steps, and/or certain steps may be omitted, without departing from the scope of the present teachings. For example, the method 330 may further include implementing the first user option via an input mechanism, e.g., touch input applied to a list of user-selectable items, which does not involve direct natural language input.

As another example, the first step 332 may further include parsing the natural language input into one or more nouns and one or more verbs; determining, based on the one or more nouns or the one or more verbs, an interaction type to be associated with the natural language input; ascertaining one or more additional attributes of the natural language input; and employing the interaction type and the one or more additional attributes (e.g., metadata) to determine a subsequent prompt or software action or command to be associated with the natural language input, and so on.

FIG. 13 is a flow diagram of a second example method 350 for facilitating implementing the embodiments of FIGS. 1-12 via use of a form and accompanying metadata to store parameters for use by software to implement one or more enterprise or actions. In the present example embodiment, data collected for an interaction is used to populate a form, which is submitted to a server to complete an enterprise operation. The user interface conversation flow may cycle through a series of questions until the form is populated with sufficient input data, retrieved data, and/or preexisting default data to implement an enterprise operation/action or data retrieval action.

The example method 350 includes an initial input-receiving step 352, which involves receiving user input, e.g., via natural language (speech or text). The input-receiving step 352 may include additional steps, such as issuing one or more prompts, displaying one or more user-selectable menu items, and so on.

Subsequently, an operation-identifying step 354 includes identifying one or more enterprise operations that pertain to the user input received in the input-receiving step 352.

A subsequent optional input-determining step 356 includes prompting a user for additional input if needed, depending upon the operation(s) to be performed, as determined in the operation-identifying step 354.

Next, a form-retrieval step 358 involves retrieving a form and accompanying metadata that will store information needed to invoke a Web service to implement one or more previously determined operations.

Subsequently, a series of form-populating steps 360-368 are performed until all requisite data is input to appropriate form fields. The form-populating steps include determining unfilled form fields in a form-field identifying step 360; prompting a user for input based on metadata and retrieving form field input, in a prompting step 362; optionally using metadata to populate additional form fields based on user input to a given form field, in an auto-filling step 364; and setting form field values based on determined form field information, in a field-setting step 366.

A field-checking step 368 includes determining if all requisite form fields have been populated, i.e., associated parameters have been entered or otherwise determined. If unfilled form fields exist, control is passed back to the form-field identifying step 360. Otherwise, control is passed to a subsequent form-submitting step 370.

Note that in certain instances, software may simultaneously populate or fill multiple form fields in response to a spoken sentence that specifies several parameters, e.g., as set forth above. Furthermore, information pertaining to one field (e.g., customer name) may be used by underlying software, e.g., with reference to metadata, to populate another field (e.g., customer identification number).

In certain embodiments, metadata may be associated with a particular form field. For example, metadata may specify that the input to the form field includes an opportunity name that is associated with another opportunity identification number field. Accordingly, upon specification of the opportunity name information, software may reference the metadata and initiate an action to retrieve the opportunity identification number information from a database based on the input opportunity name. The action may further populate other form fields in preparation for submission of the form to server-side processing software.

After population of form fields, the form-submission step 370 is implemented. The form-submission step 370 includes submitting the populated form and/or data specified therein to a Web service or other software to facilitate implementing the identified operation(s).

Next, an optional context-setting step 372 may provide context information to underlying software to facilitate interpreting subsequent user input, e.g., commands, requests, and so on.

Subsequently, an optional follow-up-operation initiating step 374 may be performed. The optional follow-up-operation initiating step 374 may involve triggering an operation in different software based on the results of one or more of the steps 352-372.

For example, underlying software can communicate with other software, e.g., Human Resources (HR) software to trigger actions therein based on output from the present software. For example, upon a user entering a request for vacation time, a signal may be sent to an HR application to inform the user's supervisor that a request is pending; to periodically remind the HR supervisor, and so on.

Next, a break-checking step 376 includes exiting the method 350 if a system break is detected (e.g., if a user exits the underlying software, turns off the mobile computing device, etc.) or passing control back to the input-receiving step 352.

While certain embodiments have been discussed herein primarily with reference to natural language processing software implemented via a Service Oriented Architecture (SOA) involving software running on client and server systems, embodiments are not limited thereto. For example, various methods discussed herein may be implemented on a single computer. Furthermore, methods may involve input other than spoken voice, e.g., input provided via text messages, emails, and so on, may be employed to implement conversation flows in accordance with embodiments discussed herein.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating user access to software functionality, the method comprising:
receiving first natural language input;
displaying electronic text representative of the first natural language input, in a conversation flow illustrated via a user interface display screen;
interpreting the natural language input and determining a command representative thereof;
employing the command to determine and display a first prompt, which is associated with a predetermined set of one or more user selectable items;
providing a first user option to indicate a user selection responsive to the first prompt; and
inserting a representation of the user selection in the conversation flow.

2. The method of claim 1, wherein providing includes providing the first user option to indicate a user selection via an input mechanism that is adapted to receive input other than natural language.

3. The method of claim 2, wherein the input mechanism includes touch input applied to a displayed list of user selectable items.

4. The method of claim 2, wherein the representation of the user selection includes electronic text that is inserted after the electronic text representative of the first natural language input.

5. The method of claim 1, wherein providing includes providing the first user option to indicate a user selection via an input mechanism that includes natural language input.

6. The method of claim 1, further including displaying a second prompt inserted in the conversation flow after the representation of the user selection, and providing a second user option to provide user input responsive to the second prompt via second natural language input, and inserting a representation of the second natural language input into the conversation flow after the second prompt.

7. The method of claim 1, wherein interpreting further includes determining that the command represents a request to view data, and further includes determining a type of data that a user requests to view, and displaying a representation of requested data in response thereto.

8. The method of claim 7, wherein the type of data includes data pertaining to a customer, and opportunity, an appointment, task, interaction, or note.

9. The method of claim 1, wherein interpreting further includes determining that the user command represents a request to create a computing object, wherein the computing object includes data pertaining to a task, an appointment, a note, or an interaction.

10. The method of claim 1, wherein interpreting includes referencing a repository of user data, including speech vocabulary previously employed by the user, to facilitate estimating user intent represented by the first natural language input.

11. The method of claim 10, wherein employing includes referencing a previously accessed computing object to facilitate determining the prompt.

12. The method of claim 1, wherein the user selection identifies a computing object to be created, or data of which is to be displayed, wherein the computing object is maintained via an Enterprise Resource Planning (ERP) system.

13. The method of claim 12, further including providing one or more additional prompts adapted to query the user for input specifying one or more parameters for input to a Web service to be called to create a computing object.

14. The method of claim 13, further including employing one or more ERP servers to provide the Web service and employing a client computer to display the conversation flow and to receive natural language input.

15. The method of claim 14, wherein the method further including providing metadata from the server to the mobile computing device to adjust a user interface display screen illustrated via the mobile computing device.

16. The method of claim 1, further including associating one or more Web services with the conversation flow based on the natural language input, and wherein the prompt includes one or more questions, responses to which represent user selections that provide answers identifying one or more parameters to be included in one or more Web service requests.

17. The method of claim 16, wherein the one or more parameters includes a customer identification number, an opportunity identification number, or an indication of an interaction type.

18. The method of claim 1, further including:
determining a type of interaction to be implemented via the conversation flow based on the first natural language user input;
determining a form applicable to the type of interaction, wherein the form is associated with updatable metadata characterizing one or more fields of the form or data thereof;
ascertaining one or more user prompts to display via a client device in the conversation flow in response to user input responsive to the one or more prompts and based on the form and associated metadata;
populating the form with data based on the user input responsive to the one or more prompts and automatically generated form input based on the metadata; and
inputting data from the form to software that is adapted to implement an action associated with the type of interaction.

19. An apparatus comprising:
a digital processor coupled to a display and to a processor-readable storage device, wherein the processor-readable storage device includes one or more instructions executable by the digital processor to perform the following acts:
receiving natural language input;
displaying electronic text representative of the natural language input, in a conversation flow illustrated via user interface display screen;
interpreting the natural language input and determining a command representative thereof;
employing the command to determine and display a prompt, which is associated with a predetermined set of one or more user selectable items;
providing a first user option to indicate a user selection responsive to the prompt; and
inserting a representation of the user selection in the conversation flow.

20. A processor-readable storage device including instructions executable by a digital processor, the processor-readable storage device including one or more instructions for:
receiving natural language input;
displaying electronic text representative of the natural language input, in a conversation flow illustrated via user interface display screen;
interpreting the natural language input and determining a command representative thereof;
employing the command to determine and display a prompt, which is associated with a predetermined set of one or more user selectable items;
providing a first user option to indicate a user selection responsive to the prompt; and
inserting a representation of the user selection in the conversation flow.
